(19) United States
(12) Patent Application Publication
(10) Pub. No.: US 2005/0105496 A1
(43) Pub. Date: May 19, 2005

(54) System and Method for Integrated Wireless WAN/LAN Location of a Device

(75) Inventor: Gary S. Ambrosino, Wellesly, MA (US)

Correspondence Address: COGNIO, INC., 20400 OBSERVATION DRIVE, SUITE 206, GERMANTOWN, MD, 20876, US

(73) Assignee: COGNIO, INC., Gaithersburg, MD (US)

(21) Appl. No.: 10/708,812

(22) Filed: Mar. 26, 2004

Related U.S. Application Data
(60) Provisional application No. 60/481,667, filed on Nov. 19, 2003.

(51) Int. Cl. H04Q 7/00; H04Q 7/24; G01S 3/02

(52) U.S. Cl. 370/338; 370/328; 455/456.6; 342/450

(57) ABSTRACT

Techniques for location tracking of devices having both wireless WAN and wireless LAN capability. A device with this dual communication capability may be triggered to initiate a wireless LAN location procedure in response to receiving a wireless WAN signal. The request for initiating the location process may be a user of the device itself, or any third party desiring knowledge about the location of the device. This process exploits the advantages of the wireless LAN location capabilities to use the wireless LAN link for accurate in-building location. Any location technique useful in a wireless LAN environment may be employed. The system and method are useful to locate any individual or object that is carrying or is tagged with device having wireless WAN and wireless LAN connectivity.

### BACKGROUND OF INVENTION

This application claims priority to U.S. Provisional Application No. 60/481,667, filed Nov. 19, 2003, the entirety of which is incorporated herein by reference.

Wireless local area network (WLAN) connectivity, such as IEEE 802.11 technology (also known as WiFi™), has proliferated into the consumer home and enterprise environment. Many enterprises rely on WLAN connectivity in place of traditional wired LANs. Moreover, there has been a recent trend to incorporate WLAN capability into other radio communication devices, such as mobile cell phones. A mobile cell phone with WLAN capability allows a user to have connectivity in both a wide area network (WAN) environment through the cell phone infrastructure as well as wireless LAN connectivity.

Techniques are being developed to locate devices operating in the wireless LANs. This has utility in maintaining the security of the wireless LAN, particularly in a corporate enterprise environment. In fact, these location techniques have much greater accuracy than the location techniques available on cell phone networks, particularly when the cell phone device goes into an indoor environment.

It would be desirable to exploit the location capabilities of wireless LANs in locating a device that has both wireless WAN and wireless LAN communication capability.

### SUMMARY OF INVENTION

Briefly, techniques are provided that enable accurate location tracking of devices having both wireless WAN and wireless LAN capability. A device with this dual communication capability may be triggered to initiate a wireless LAN location procedure in response to receiving a wireless WAN signal. The request for initiating the location process may be a user of the device itself, or any third party desiring knowledge about the location of the device. This process exploits the advantages of the wireless LAN location capabilities to use the wireless LAN link for location determination which may be more accurate than wireless WAN and/or global positioning system (GPS) location techniques. Any location technique useful in a wireless LAN environment may be employed. The system and method described herein are useful to locate any individual or object that is carrying or is tagged with a device having wireless WAN and wireless LAN connectivity.

Other objects and advantages of the present invention will become more readily apparent when reference is made to the following description in conjunction with the accompanying drawings.

### BRIEF DESCRIPTION OF DRAWINGS

FIG. 1 is block diagram of a system in which the integrated WAN/LAN location process may be performed.

FIG. 2 is a flow chart diagram of an integrated WAN/LAN location process.

FIG. 3 is a flow chart diagram of an integrated WAN/LAN location process suitable for emergency (e911) and other situations.

FIG. 4 is a block diagram of a device having wireless LAN and wireless WAN communication capability.

### DETAILED DESCRIPTION

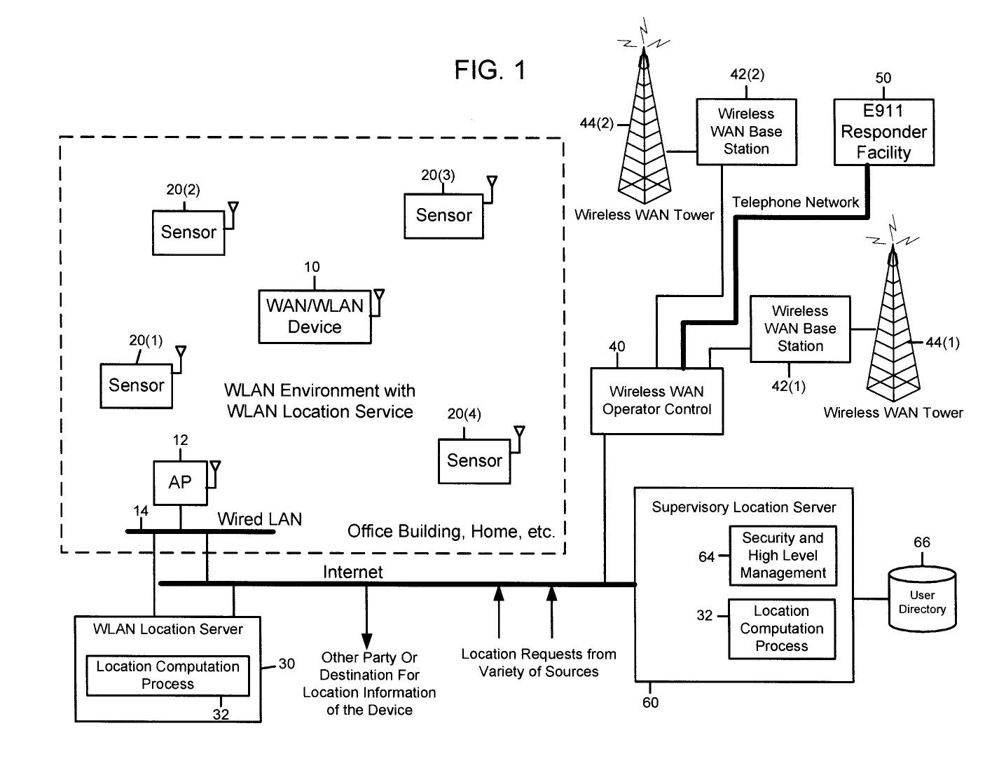

Referring first to FIG. 1, an environment is shown in which an integrated wireless wide area network/local area network (WAN/LAN) location process is performed to locate a device 10 having both wireless WAN communication capability and wireless LAN communication capability (also referred to as IP-capable). Examples of such devices are mobile phones, one-way and two-way pagers, wireless two-way messaging devices (e.g., Blackberry™ devices) and examples of WAN communication capability are mobile cellular telephone services (using AMPS, TDMA, CDMA or GSM standards), one-way and two-way paging services, wireless two-way messaging devices. An example of wireless LAN capability is an IEEE 802.11 wireless LAN. In addition, the device may have Voice-Over-Internet Protocol (VoIP) communication capability to make voice calls over the Internet via a wired or wireless LAN.

The integrated wireless WAN/LAN location process uses the relatively long-range communication capabilities of the wireless WAN to contact the device, and then uses the relatively short-range communication capabilities to more accurately determine the physical location of the device. The location information may be delivered to a variety of different types of parties that either request or may be interested in the location information. However, according one embodiment described hereinafter, a device having wireless VoIP communication capabilities may initiate the wireless LAN location procedure without necessarily resorting to the wireless WAN system.

FIG. 1 shows a wireless LAN environment in which the device 10 operates. In that environment, there is one or more wireless LANs access points (APs) 12. There are also one or more sensors 20(1) to 20(4) that are useful in a wireless LAN location process. The sensors 20(1) to 20(4) may be wireless LAN devices, e.g., APs or stations (STAs) that are capable of receiving signals transmitted by other wireless LAN devices, including device 10, and collecting data therefrom that is useful in a wireless LAN location process. The AP 12 and the sensors 20(1) to 20(4) are also connected to a wired LAN 14. A WLAN location server 30 is provided that executes a WLAN location process shown at reference numeral 32 using data collected by one or more of the sensors 20(1) to 20(4). The wired LAN 14 may in turn be connected to the Internet shown at reference numeral 32.

The wireless WAN portion of the system includes a wireless WAN operator control center 40 that connects to a plurality of wireless WAN base stations, which in this example two are shown 42(1) and 42(2). Each base station 42(1) and 42(2) connects to a wireless WAN tower 44(1) and 44(2), respectively, that transmits and receives wireless WAN signals to and from wireless WAN capable devices, including device 10.

As appreciated by those with ordinary skill in the art, a wireless WAN system can communicate with devices over relatively large distances between the base station and the device, when the device is located both indoor and outdoors. In this sense, it is a relatively long-range communication system as compared to a wireless LAN system in which a device can communicate over relatively smaller distances between and AP and a device. A unique aspect of the method described herein is that the WAN system can be exploited to contact a device to be located that is otherwise in an area where wireless WAN or GPS location techniques are not as accurate or perhaps not possible. Once contacted, the WAN system can send a signal to the device that causes the device to initiate a wireless LAN location procedure with respect to a wireless LAN in proximity to the device.

Another component of the system is a supervisory location server 60 that performs security and higher level management 64 in connection with the integrated wireless WAN/LAN location process and may optionally perform the location computations 32 associated with the wireless LAN location process. The supervisory location server 60 may cooperate with a user directory 66 that stores security, identifier and related information for the wireless WAN/LAN capable devices for which the location services is to be provided. The user directory 66 stores identifier and authentication information about each of the devices that can be located, and also about each of the parties a user of the device may designate as authorized to receive location information about the device. This information is used to authenticate a device and a party requesting location information about the device to provide adequate security and privacy with respect to the location of the device.

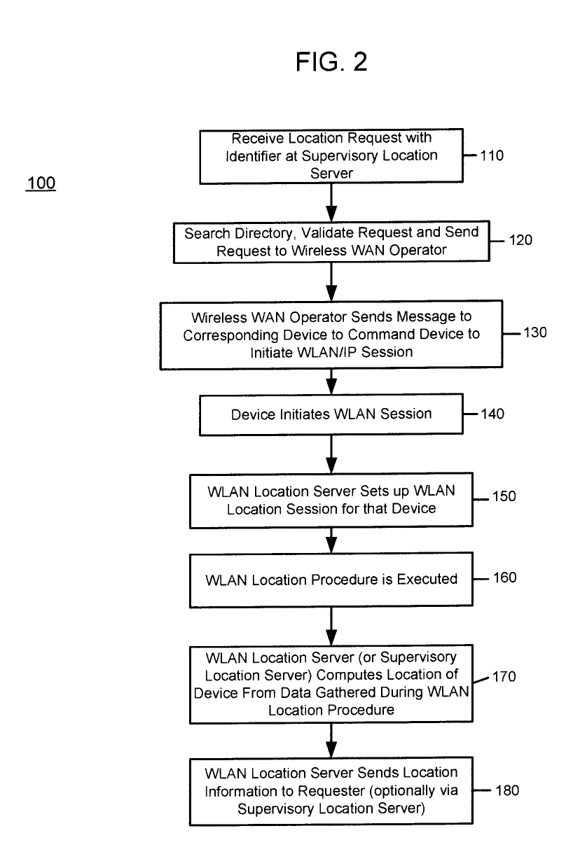

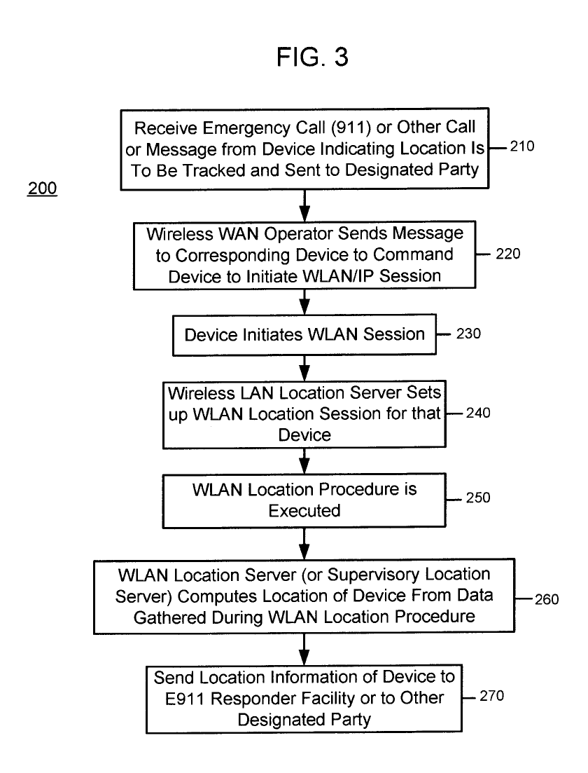

There are many ways to initiate the location process. According to one method, shown in FIG. 2, the location process is initiated by a request from a third party that wishes to locate the device 10. For example, the third party may be a friend, family member, co-worker, employer, etc., that wishes to know the precise location of an individual using or carrying the device 10. According to another method, shown in FIG. 3, the device 10 itself initiates the location process, and one application of this method is emergency (e.g., e911) condition location. For example, the user of the device 10 may be faced with an emergency condition and his/her location needs to be determined for use by an emergency responder facility. Alternatively, a user of the device may wish to initiate the location process to forward device location information to a designated party, on a periodic or on-demand basis.

The flow charts shown in FIGS. 2 and 3 illustrate steps performed in one or more of: the device 10, the WLAN server 30, the supervisory location server 60 and the wireless WAN operator control equipment 40 (in connection with a WAN base station and WAN tower) as part of the location process described herein.

The process of FIG. 2 is first described, in conjunction with FIG. 1. A location request is received in step 110 at the supervisory location server 60. In the request, the device to be located is identified through an identifier, such as cell phone number, e-mail address, multimedia message service (MMS) address, short messaging service (SMS) address, etc. The location request message may originate from a party at a personal computer, cellular phone, or other wired or wireless communication devices, and may be an e-mail, voice command, MMS message, etc., or from a computer facility that is programmed to automatically track the location of the device. In step 120, the supervisory location server 60 receives the message and through information stored in the database authenticates the party requesting the location information and the device to be located. Once this information is authenticated, the supervisory location server 60 generates and sends an MMS or other data-link based message to the wireless WAN operator equipment commanding the WAN operator to trigger the device 10 engage in the location process. In step 130, the wireless WAN operator equipment sends a wireless LAN location initiate message to the device 10 commanding it to initiate a wireless LAN location procedure. This message may include a list of IP addresses for WLAN location servers that are available for WLAN location services. Alternatively, the location request message is sourced as explained above, but rather than being sent to the supervisory location server 60, it is sent directly to a server that is part of a WAN location service, that in step 130, routes an MMS or other data-link based location session request message through wireless WAN infrastructure to the device 10.

In the device 10, there is a location session software process or other functionality that processes the wireless LAN location initiate message and in response causes the device 10 in step 140 to initiate a wireless LAN location procedure with a WLAN location server, such as server 30. When the device 10 receives the wireless LAN location initiate message from the wireless WAN operator equipment, it may already be associated with an AP. If not, it will attempt to associate by sending a Beacon frame or a request-to-send (RTS) frame or other suitable 802.11 frame to a WLAN AP. In any event, once associated with an AP, in step 140, the device 10 sends a location start session message (including a verification identifier) addressed to WLAN location server 30 (or any other WLAN location server identified in the message related to the device 10 in step 130) via an AP. When the WLAN location server 30 receives the location start session message via the AP from the device 10, further authentication may be conducted by exchanging information with the supervisory location server 60 for verification against data in the user directory 66 based on name, cell phone number, MMS address, etc. to be sure the device 10 is authenticated before initiating the location process.

The WLAN location server 30 starts a location process in step 150 by sending location set-up messages to the device 10 and to sensors 20(1)-20(4) that will participate in the location procedure. In response to receiving the location set-up messages, the sensors 20(1) to 20(4) prepare for the WLAN location procedure.

Step 160 represents execution of the WLAN location procedure. The types of signals transmitted, data captured, measurements made and computations performed in step 160 depend on the specific type of WLAN location procedure employed. Any procedure suitable for use in the WLAN environment may be employed in connection with the processes described herein. Some WLAN location procedures involve collecting data at one or more sensors 20(1) to 20(4) associated with the transmission of one or more signals by the device 10 (and optionally transmission of signals by one of the sensors at a corresponding known location). The sensors 20(1) to 20(4) send collected data to the WLAN location server 30 that executes a location computation in step 170 to compute the location of the device 10. In step 180, the location server 30 then sends location information to the requester, either directly or through the supervisory location server to the requester, via an email message. Alternatively, the location information may be conveyed to the requester through the wireless WAN operator control equipment 40 in the form of an email, voice message, call back number, web page link to a map view, etc. The location information may take the form of coordinates, street address, building room location, as well as graphical information showing the three-dimensional location of a device within a building, etc.

The advantage of the wireless LAN location process is that it provides higher resolution location accuracy of the device that is to be located, and also in many cases, locates the device in conditions where a wireless WAN location process (GPS, and other known wireless WAN location techniques) could not locate the device.

Upon completion of the location computation, the location server 30 may send a message that instructs the device 10 to terminate the WLAN connection in order to save power on the device 10. However, if the device 10 is using the WLAN connection for voice or data communications, it may maintain the link for this purpose and the location server 30 may continue tracking the location of the device based on transmissions back and forth with an AP using data captured at the sensors in proximity to the device 10.

FIG. 3 shows a location process 200 whereby the triggering event to start the location process originates at the device 10. Reference is also made to FIG. 1. For example, a user of the device may initiate an emergency call, such as a 911 call, through the wireless WAN operator equipment. Alternatively, the user of the device 10 may wish to preemptively convey location information to a particular destination, person or entity, and the procedure shown in FIG. 3 may be employed for that purpose as well. In step 210, a call or message is received from the device 10 at the wireless WAN operator equipment. The call may be an emergency (911) call, or a call or message from the device 10 indicating that location information should be sent to a party identified or designated in the call or message (by email address, phone number, etc.). In response, in step 220, the wireless WAN operator equipment sends a message (similar to the type of message sent in step 130 in FIG. 1) to cause the device 10 to initiate a WLAN location session. Steps 230, 240, 250 and 260 are similar to steps 140, 150, 160 and 170 in FIG. 1. In step 270, the WLAN location server 30 or supervisory location server 60 sends the location information about device 10 to the emergency responder facility 50, or to some other party or destination that device 10 designates to receive location information about the device 10.

In the event that the device 10 has VoIP capability via a wireless LAN, the process shown in FIG. 3 may be modified to trigger off an emergency VoIP (e911) call, in which an emergency condition of the call, or other designated information in the message sent by the device, is detected at a more locally positioned gateway, server or router connected to the wireless LAN that routes VoIP calls over the Internet. This device would detect the emergency condition and send a message to the wireless device 10 to initiate the WLAN location procedure as depicted in steps 220 through 270 in FIG. 3. Alternatively, if a WLAN location procedure has already been conducted for the device 10, the location information for that device is automatically routed to an emergency responder facility 50 in response to the emergency VoIP call. And again, this process may be similarly applied to an application in which the VoIP call or message initiates a location procedure to send location information about the device to a particular party designated by the device 10 in the VoIP call or message.

While the foregoing description of FIGS. 2 and 3 suggests that the location information may be computed at the WLAN server 30, it should be understood that it may be computed by the supervisory location server 60. In the latter case, the data collected by the sensors 20(1) to 20(4) would be sent via the Internet (if is not connected to the LAN of the sensors) to the supervisory location server 60 for computation. Alternatively, the location computation may be performed by a computation device located and coupled to one or more of the sensors 20(1) to 20(4).

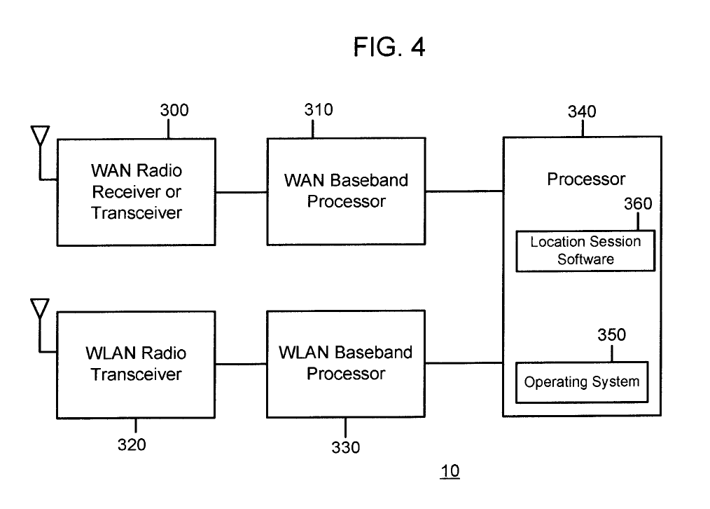

Referring to FIG. 4, a high level block diagram of the device 10 is shown. The device 10 has a wireless WAN receiver or transceiver 300 and a baseband processor 310 that may be part of a wireless WAN chipset of any of the varieties known in the art. In addition, the device 10 has a WLAN radio transceiver 320 (e.g., IEEE 802.11a, b and/or g) and a WLAN baseband processor 330 that may be part of an 802.11 chipset. A processor 340 is coupled to the baseband processor 310 and the WLAN baseband processor 330 to perform higher level control of the device. As is known in the art, the processor 340 executes an embedded operating system 350 that is capable of supporting one or more applications, such as Java applets, Qualcomm's BREW™ technology or other similar software application platforms useful in wireless communication devices. The location session manager software, described above in connection with FIGS. 2 and 3, is shown at reference numeral 360 and may take the form of one of these software applications. It should be understood that it is possible that the WAN receiver or transceiver and baseband components may be integrated with the WLAN radio transceiver and baseband components. The location session management software 360 and other software may be embodied by processor readable instructions encoded on a processor readable medium (e.g., memory included in or associated with) the processor 360.

The wireless LAN location process used in conjunction with the process described herein may be any heretofore known or hereinafter developed methodology and system for locating devices operating in a wireless LAN environment. Known location techniques employ time of arrival (TOA), time difference of arrival (TDOA), and received signal strength with respect to one or more signals transmitted by the device to be located. For a TDOA-based location system, see, for example, commonly assigned and co-pending U.S. application Ser. No. 10/409,563, filed Apr. 8, 2003, and entitled “System and Method for Locating Wireless Devices in an Unsynchronized Wireless Environment,” the entirety of which is incorporated herein by reference. Examples of location processes that operate on received signal strength information are described, for example, in U.S. Pat. No. 6,674,403 B2 and International Patent Publication No. WO 02/054813A1, which are incorporated herein by reference. The details of these location procedures are not described herein, but may be found in the aforementioned and other documents describing these techniques.

To summarize, a method is provided for determining the physical location of a device that has both wireless wide area network (WAN) communication capability and wireless local area network (LAN) communication capability, comprising steps of receiving a signal at the device from wireless WAN equipment that causes the device to initiate a wireless LAN location process; and executing the wireless LAN location process to determine the physical location of the device. Said another way, a method is provided for determining the physical location of a device that has both wireless relatively long-range communication capability and wireless relatively short-range communication capability, the method comprising steps of: receiving a relatively long-range communication signal at the device from wireless equipment that causes the device to initiate a wireless short-range location process; and executing the wireless short-range location process to determine the physical location of the device.

From the perspective of the steps performed in the device itself, the method generally comprises steps of receiving a signal from wireless WAN equipment that is intended to initiate a location procedure to locate the device; and initiating a wireless LAN location process in response to receiving the signal.

In addition, in the context of the steps performed in the device itself, a processor readable medium is provided that is encoded with instructions that, when executed by a processor, perform steps of processing a signal received from wireless WAN equipment that is intended to initiate a location procedure to locate a device that receives the signal; and initiating a wireless LAN location process in response to receiving the signal. Similarly, a processor readable medium is provided that is encoded with instructions that, when executed by a processor, perform steps of generating a wireless signal for transmission from the device, wherein the wireless signal includes information that indicates a location procedure is to be performed with respect to the device; and initiating a wireless LAN location process to determine the physical location of the device.

Moreover, a method is provided for determining the physical location of a device that has both wireless wide area network (WAN) communication capability and wireless local area network (LAN) communication capability, comprising steps of: transmitting a wireless signal from the device, wherein the wireless signal includes information that indicates a location procedure is to be performed with respect to the device; and executing a wireless LAN location process to determine the physical location of the device.

Further still, a wireless radio communication device is provided comprising a radio receiver that receives wireless wide area network (WAN) signals; a radio transceiver that transmits and receives wireless local area network (LAN) signals; and a processor coupled to the radio receiver and to the radio transceiver that processes a signal received by the radio receiver from wireless WAN equipment that is intended to initiate a location procedure to enable the device to be located, and initiating a wireless LAN location process in response to receiving the signal.

From the perspective of a server that manages or participates in a process for locating a device that has both wireless wide area network (WAN) communication capability and wireless local area network (LAN) communication capability, the method comprising steps of: receiving from a party a request to locate the device; verifying the party making the request and the device to be located; sending a signal to wireless WAN equipment that caused the wireless WAN equipment to transmit a signal to the device the causes the device to initiate a wireless LAN location process; and receiving location information determined from the wireless LAN location process and delivering the location information to the party.

The above description is intended by way of example only.

1. A method for determining the physical location of a device that has both wireless wide area network (WAN) communication capability and wireless local area network (LAN) communication capability, the method comprising steps of:
a. receiving a signal at the device from wireless WAN equipment that causes the device to initiate a wireless LAN location process; and
b. executing the wireless LAN location process to determine the physical location of the device.

2. The method of claim 1, wherein the step of receiving comprises receiving a signal of a type selected from the group consisting of: mobile cell phone signal, multimedia messaging signal, short messaging signal and one-way or two-way paging signal.

3. The method of claim 1, and further comprising the step of receiving a location request that includes an identifier of the device to be located.

4. The method of claim 3, in response to receiving the location request, further comprising the step of sending a signal to the wireless WAN equipment that requests the wireless WAN equipment to transmit the signal that causes the device to initiate the wireless LAN location process.

5. The method of claim 3, wherein the step of receiving the location request comprises receiving a signal including an identifier selected from the group consisting of: name of device user, e-mail address, telephone number, multimedia messaging address, short messaging address, and pager number.

6. The method of claim 3, and further comprising the step of verifying at least one of the identifier of the device and the party requesting the location of the device.

7. The method of claim 1, wherein the step of executing the wireless LAN location process comprises executing a process that computes the location of the device based on one or more of: time of arrival data, time difference of arrival data, and received signal strength data, derived from a signal transmitted by the device.

8. The method of claim 1, and further comprising the step of executing a software application in the device that initiates the wireless LAN location process.

9. The method of claim 1, and further comprising, at a computing device coupled to the wireless LAN, generating at least one signal to be transmitted by a wireless LAN device to the device and one or more other wireless LAN devices in order to set-up the wireless LAN location process.

10. The method of claim 9, and further comprising, at the computing device, the step of processing data derived from one or more signals transmitted by the device to be located to determine the physical location of the device.

11. The method of claim 1, and further comprising the step of terminating a wireless LAN connection at the device after completion of the wireless LAN location process.

12. The method of claim 1, and further comprising the step of receiving at the wireless WAN equipment an emergency call from the device, and in response, transmitting the signal to the device that causes the device to initiate the wireless LAN location process.

13. The method of claim 12, and further comprising the step of sending information describing the physical location of the device to an emergency responder facility.

14. The method of claim 1, and further comprising the step of downloading to the device a software application that the device uses to initiate the wireless LAN location process in response to receiving the signal from the wireless WAN equipment.

15. The method of claim 1, and further comprising the step of sending location information of the device to a party.

16. The method of claim 15, wherein the step of sending comprises sending the location information in the form of: an email message, voice message, paging message or web page link, and an identifier of the party is designated by a user of the device.

17. The method of claim 15, wherein the step of sending comprises sending location information of the device to a party that requested location of the device.

18. The method of claim 17, wherein the wireless WAN equipment transmits the signal to the device in response to receiving a request for location of the device by the party.

19. A method in a device that has wireless wide area network (WAN) communication capability and wireless local area network (LAN) communication capability, the method comprising steps of:
a. receiving a signal from wireless WAN equipment that is intended to initiate a location procedure to locate the device; and
b. initiating a wireless LAN location process in response to receiving the signal.

20. The method of claim 19, wherein the step of initiating comprises executing a software application in the device.

21. The method of claim 19, wherein the step of initiating comprises transmitting a signal intended for processing by a computing device coupled to the wireless LAN.

22. The method of claim 21, wherein in response to receiving the signal from the device further comprising the step of receiving a signal generated by the computing device that sets up the wireless LAN location procedure.

23. The method of claim 19, and further comprising the step of terminating a wireless LAN connection after completion of the wireless LAN location process.

24. The method of claim 19, and further comprising the step of initiating a wireless LAN connection if the device is not already connected to the wireless LAN when it receives the signal from the wireless WAN equipment.

25. The method of claim 19, and further comprising the step of placing a call or sending a message that is processed by the wireless WAN equipment, which in response, transmits the signal to the device that causes the device to initiate the wireless LAN location process.

26. The method of claim 25, wherein the step of placing the call comprises placing an emergency call.

27. A method for determining the physical location of a device that has both wireless wide area network (WAN) communication capability and wireless local area network (LAN) communication capability, the method comprising steps of:
a. transmitting a wireless signal from the device, wherein the wireless signal includes information that indicates a location procedure is to be performed with respect to the device; and
b. executing a wireless LAN location process to determine the physical location of the device.

28. The method of claim 27, wherein the step of transmitting comprises transmitting a wireless LAN signal.

29. The method of claim 28, wherein the step of transmitting comprises placing a voice-over-IP call.

30. The method of claim 28, and further comprising the step of receiving the wireless signal from the device, at a computing device, transmitting a signal to the wireless device to set-up the wireless LAN location procedure.

31. The method of claim 30, wherein the step of executing comprises computing the location of the device based on data derived from at least one signal transmitted by the device and received at one or more other wireless LAN devices.

32. The method of claim 27, wherein the step of transmitting comprises transmitting a wireless WAN signal.

33. The method of claim 32, wherein the step of transmitting comprises placing an emergency call.

34. The method of claim 32, wherein the step of transmitting comprises transmitting a message that includes an identifier of a party or destination to receive location information about the device.

35. The method of claim 27, and further comprising the step of receiving the signal at wireless WAN equipment, and in response thereto, transmitting a signal to the device that causes the device to initiate the wireless LAN location.

36. A wireless communication device comprising:
a. a radio receiver that receives wireless wide area network (WAN) signals;
b. a radio transceiver that transmits and receives wireless local area network (LAN) signals; and
c. a processor coupled to the radio receiver and to the radio transceiver that processes a signal received by the radio receiver from wireless WAN equipment that is intended to initiate a location procedure to enable the device to be located, and initiating a wireless LAN location process in response to receiving the signal.

37. The device of claim 36, wherein the processor generates the signal for transmission via the wireless LAN to a computing device coupled to the wireless LAN, and processes a signal received from the computing device that sets up the wireless LAN location procedure.

38. A method for managing a process for locating a device that has both wireless wide area network (WAN) communication capability and wireless local area network (LAN) communication capability, the method comprising steps of:
a. receiving from a party a request to locate the device;
b. verifying the party making the request and the device to be located;
c. sending a signal to wireless WAN equipment that caused the wireless WAN equipment to transmit a signal to the device the causes the device to initiate a wireless LAN location process; and
d. receiving location information determined from the wireless LAN location process and delivering the location information to the party.

39. A method for determining the physical location of a device that has both wireless relatively long-range communication capability and wireless relatively short-range communication capability, the method comprising steps of:
a. receiving a relatively long-range communication signal at the device from wireless equipment that causes the device to initiate a wireless short-range location process; and
b. executing the wireless short-range location process to determine the physical location of the device.

40. A processor readable medium encoded with instructions that, when executed by a processor, perform steps of:
a. processing a signal received from wireless WAN equipment that is intended to initiate a location procedure to locate a device that receives the signal; and
b. initiating a wireless LAN location process in response to receiving the signal.

41. A processor readable medium encoded with instructions that, when executed by a processor, perform steps of:
a. generating a wireless signal for transmission from the device, wherein the wireless signal includes information that indicates a location procedure is to be performed with respect to the device; and
b. initiating a wireless LAN location process to determine the physical location of the device.
